(19) United States
(12) Patent Application Publication
(10) Pub. No.: US 2015/0333377 A1
(43) Pub. Date: Nov. 19, 2015

(54) Battery with Power Disconnect

(71) Applicant: QUALCOMM Incorporated, San Diego, CA (US)

(72) Inventors: Phillip DAVILA, San Diego, CA (US); Julian Rosenthal, Encinitas, CA (US); Thomas George Chrisopulos, Escondito, CA (US)

(73) Assignee: QUALCOMM Incorporated, San Diego, CA (US)

(21) Appl. No.: 14/277,198

(22) Filed: May 14, 2014

(51) Int. Cl. H01M 10/42; H01M 2/34

(52) U.S. Cl. CPC H01M 10/425; H01M 2/34; H01M 2220/30; H01M 2010/4271

(57) ABSTRACT

Devices, systems, and methods for disconnecting battery power to a load device include a battery with a housing containing a main energy storage element, an internal switch, and a control unit, as well as terminals through the housing for electrically coupling to the load device. The internal switch may include a first switch lead connected to the main energy storage element and a second switch lead connected to at least one of the terminals. The control unit, coupled to the internal switch, may open or close the internal switch in response to receiving an actuation signal. The main energy storage element supplies power or is disconnected from supplying power to the load device when the internal switch is closed or opened respectively.

### BACKGROUND

Most sophisticated computing devices powered by an onboard battery experience circumstances when they become unresponsive, such as due to a software bug. A common and effective solution to an unresponsive computing device is to remove physically the battery from the device. Unlike simply shutting off the device, physically removing the battery from its contacts open-circuits the device, completely discharging powered circuits and providing a more complete system reset. Although simple, removing the battery is a somewhat cumbersome process for end users. Development, integration, or quality assurance environments also more frequently face circumstances in which physically removing the battery can delay testing and drive up costs.

### SUMMARY

Various embodiments include devices and circuits, internal to a battery, as well as methods implemented in such devices and circuits, for controlling a powered state of a load device powered by the battery. In particular, various embodiments include a battery having an internal switch capable of effectively disconnecting and/or reconnecting the battery power from the contacts supplying a load device with power. A control unit, which may be part of or coupled to the internal switch, may be configured to receive signals from a remote source (i.e., external to the battery) for controlling the internal switch. Activation of the internal switch, directly open-circuits and/or prevents the load device from drawing power from the battery.

In some embodiment devices, the battery may include a main energy storage element, two or more terminals for coupling the battery to the load device, the internal switch, a control unit, and a housing at least partially enclosing the battery components. The control unit may be configured to open and/or close the internal switch in response to receiving an actuation signal. The main energy storage element and/or an auxiliary energy storage element may power the control unit. The internal switch may include a first switch lead connected to the main energy storage element and a second switch lead connected to the first one of the two terminals. A second one of the two terminals may be connected to the main energy storage element. The main energy storage element may supply the load device with power when the internal switch is closed and the load device loses power from the main energy storage element when the internal switch is open. The housing may contain the main energy storage element, the internal switch, and the control unit, while the two terminals may extend outside of the housing for coupling to the load device.

In various embodiments, the internal switch may include a retractor. The two terminals may be moved by the retractor between a first position in which the two terminals are configured to engage connector leads of the load device in a fixed position and a second position in which the two terminals are spaced away from the connector leads of the load device in the fixed position. In the first position of the terminals, the internal switch may be closed and in the second position of the terminals, the internal switch may be open.

In various embodiments, the control unit may remain powered when the internal switch is open. The control unit may remain powered by the main energy storage element when the internal switch is open. The battery may further include the auxiliary energy storage element inside the housing. The auxiliary energy storage element may power the control unit when the internal switch is open. The control unit may also include a receiver module for receiving the actuation signal from a remote source. The receiver module may include an antenna, a radio frequency identification (RFID) reader, a bus connection extending outside of the housing, and/or a magnetic reader. The control unit may further include a timer. The timer may measure the lapse of a predetermined period, and the control unit may be configured to automatically close the internal switch upon expiration of the predetermined period.

In various embodiments, the control unit may include a memory, an input bus, and a processor coupled to the memory, the input bus, and the internal switch. The processor may be configured with processor-executable instructions to perform operations including receiving a first switch signal via the input bus, storing the first switch signal in the memory, and opening the internal switch in response to receiving the first switch signal. The operations may further include receiving a second switch signal via the input bus, storing the second switch signal in the memory, and closing the internal switch in response to receiving the second switch signal.

Further embodiments include a method of performing the various operations performed by the battery discussed above.

Further embodiments include a computing device having means for performing functions corresponding to the method operations discussed above.

Further embodiments include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a schematic diagram of a battery with power disconnect according to various embodiments of the disclosure.

FIG. 2 is a component block diagram of a load device including a battery with power disconnect according to various embodiments of the disclosure.

FIG. 3 is a circuit block diagram illustrating exemplary portions of a battery with power disconnect according to various embodiments of the disclosure.

FIG. 4 is a schematic circuit block diagram of another battery with power disconnect according to various embodiments of the disclosure.

FIG. 5 is a schematic circuit block diagram of a portion of a load device engaged with a battery with power disconnect according to various embodiments of the disclosure.

FIG. 6 is a schematic circuit block diagram of a portion of another load device engaged with a battery with power disconnect according to various embodiments of the disclosure.

FIG. 7 is a communication flow diagram for various scenarios in accordance with various embodiments of the disclosure.

FIG. 8 is a communication flow diagram for various additional scenarios in accordance with various embodiments of the disclosure.

FIG. 9 is a process flow diagram illustrating an embodiment method for operating a battery with power disconnect.

FIG. 10 is a process flow diagram illustrating another embodiment method for operating a battery with power disconnect.

FIG. 11 is a schematic component diagram illustrating a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “energy storage element” or “power source,” are used interchangeably herein to refer to a supply or source of electric energy for delivery to a load device. The load devices may be connected to the main energy storage element or power source through a plug, socket, terminal, receptacle or other connection for normal operation. One of the first and second main energy storage element leads may be positively charged and the other of the first and second main energy storage element leads may be negatively charged. The leads of the main energy storage element or any circuit component are connection points within a circuit configured to convey electric current, particularly from the main energy storage element.

The terms “load device” as used herein to refer to any electrical appliance that uses and draws current from an onboard or connected battery housing the main energy storage element. The load device may be any electrical device from a small consumer electronic device to a large-scale commercial appliance. For example, the load device may refer to any one or all of laptop computers, tablet computers, smart books, palm-top computers, cellular telephones, smart phones, personal or mobile multi-media players, personal data assistants (PDA's), wireless electronic mail receivers, multimedia Internet enabled cellular telephones, streaming media players, digital media players, and similar electronic devices that include an onboard battery.

In various embodiments, the battery includes an internal switch capable of effectively disconnecting and reconnecting the battery power from the contacts supplying the load device with power. A control unit, which may be part of or coupled to the internal switch, may be configured to receive signals from a remote source (i.e., external to the battery) for controlling the internal switch. Activation of the internal switch directly open-circuits and/or prevents the load device from drawing power from the battery. This allows a complete discharge of power circuits of the load device, thereby suspending instruction execution, clearing volatile memory, and enabling a hard restart of the device. A reactivation of the internal switch may reapply power from the battery to the load device.

With the exception of the inclusion of the internal switch and control unit, the battery with power disconnect of the various embodiments may meet the physical and power supply specifications/characteristics of normal batteries. In other words, an embodiment battery may meet the form, fit and functional requirements for a battery for any of a variety of compact electronic devices, such as mobile phones, tablets, or laptops, while maintaining comparable charge-time. Thus, the battery's housing and power terminals may be configured to match the size and position of existing batteries.

The battery of various embodiments may be remotely operable, enabling remote control of the internal switch in order to enable disconnecting the battery from the load without having to open the electronic device to remove the battery or placing some mechanical interface between the battery terminals and the corresponding terminals of the load device. For example, the internal switch may be activated (opened or closed) via a micro-USB (universal serial bus) connection (i.e., a wired solution) or a Bluetooth® receiver (i.e., a wireless solution). The control unit may be software controlled or designed for automatic response to particular inputs. In this way, the control of the internal switch may be independent from the load device receiving power from the battery. Embodiment batteries may be useful in electronic devices that their manufacturers or vendors do not allow end users to pull or access the battery without voiding a warranty.

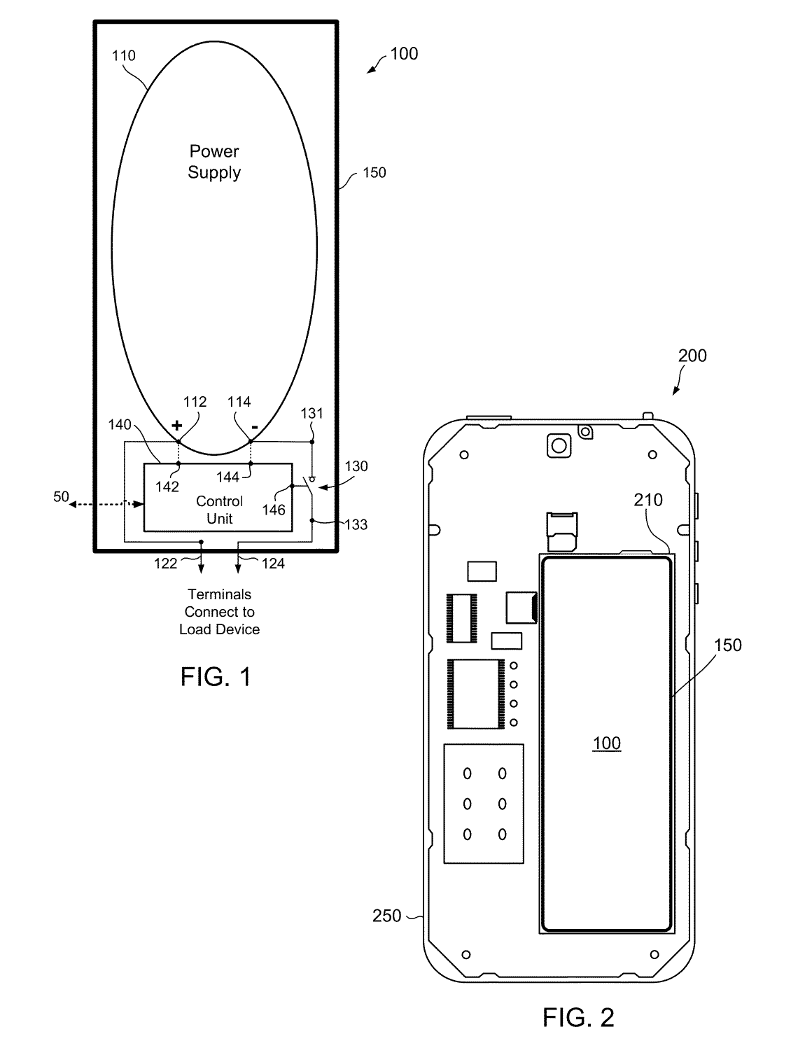

FIG. 1 illustrates an embodiment battery 100 for supplying electrical energy to a load device. The battery 100 may include a main energy storage element 110, two terminals 122, 124 for electric discharge to the load device (although other embodiments may include more than two terminals), an internal switch 130 for affecting a power disconnect, a control unit 140 for actuating the internal switch 130, and a housing 150 containing the various battery components. The main energy storage element 110 may be any form of rechargeable or non-rechargeable battery cell or cells, or a fuel cell. The battery 100 may be implemented as a standalone unitary device sized and configured to be loaded or plugged into the load device. In this way, the battery 100 may be integrated as a permanent component of the load device or designed as a removable and/or replaceable device. In addition, the battery 100 may be implemented in a variety of forms, such as a rechargeable energy cell that may be discharged and recharged repeatedly. Alternatively, the battery 100 may be implemented as a single-use or “disposable” device, which may be used and discarded once discharged or otherwise needs replacing. As a standalone unitary device, the battery 100 may be designed to replace or be used in place of existing contemporary batteries that do not include integrated power disconnect elements.

The main energy storage element 110 may include one or more energy storage cells, such as electrochemical cells that convert stored chemical energy into electrical energy (e.g., lithium ion, nickel metal hydride, nickel cadmium, or lead-acid battery cells). Each cell may contain a cathode 112 coupled to a positive terminal 122 and an anode 114 coupled to a negative terminal 124. When the load device is connected and drawing power, ions may move between the electrodes (i.e., cathode 112 and anode 114) via the two terminals 122, 124, which allows current to flow out of the battery 110 to supply energy to the load device. The size and/or capacity of the main energy storage element 110 may be configured to suit the needs of a particular load device for which it is designed. Thus, elements such as the delivered voltage, amperage, and current, may be customized to meet requirements for the load device.

The two terminals 122, 124 are the points at which a conductor from the battery's electrical components end and provide a paired connection to external circuits of the load device. The two terminals 122, 124 may include the end of a wire (or other conductive material) or be fitted with a connector or fastener for coupling to the load device. The coupling may be temporary, may require a tool for assembly and removal, or may be a permanent electrical joint between the battery 100 and the load device. Although the two terminals 122, 124 are illustrated as being associated with a particular charge (i.e., “+” for positive charge and “−” for negative charge), those charges may be reversed/reconfigured by coupling each terminal to the opposite electrodes 112, 114 or the electrodes 112, 114 may be reversed. The two terminals 122, 124 extend outside the housing 150 for coupling to the load device. While the two terminals 122, 124 are shown adjacent one another at one end of the battery 100, they may be positioned almost anywhere on the battery exterior, and need not be adjacent one another. The position of the two terminals 122, 124 may match a fixed position of corresponding terminals of the load device for mating engagement therewith.

The internal switch 130 may be an internal battery component capable of interrupting, redirecting, and/or substantially limiting the current otherwise delivered by the battery 100 to the load device. In addition, the internal switch 130 may be reversible in order to restore and/or deliver the current from the battery to the load device. The internal switch 130 may be an electromechanical device with one or more sets of electrical contacts, connected to conductors of the battery current flow. Each set of electrical contacts may be in one of two states; either “closed,” meaning the contacts are touching and electricity can flow between them, or “open,” meaning the contacts are separated and the internal switch is non-conducting. The internal switch 130 may include a first switch lead 131 connected to the main energy storage element 110 (e.g., electrode 114) and a second switch lead 133 connected to one of the two terminals (e.g., terminal 124). In addition, a gate of the internal switch 130 may connect to a control lead 146 of the control unit 140. In this way, the control unit 140 may actuate the internal switch 130 for interrupting the current or diverting it from one conductor to another. Internal switch 130 may act as a “kill switch,” for incapacitating or resetting the load device 200 in which the battery 100 is installed.

When the internal switch 130 is closed, the main energy storage element 110 may supply the load device with power. In addition, the load device may lose power from the main energy storage element 110 when the internal switch 130 is open. The internal switch 130 may open an internal circuit of the battery or physically separate one or both terminals 122, 124 from their connection with the load device. In addition, the internal switch 130 may be an electro-optical, vacuum tube or other relay capable of opening and/or closing an electric circuit. The internal switch 130 may be implemented using an electromagnet, such as a solenoid, to operate a switching circuit mechanically. Alternatively, the internal switch 130 may use exclusively solid-state relays, thereby opening or closing the circuit while eliminating and/or minimizing moving parts.

In response to receiving an actuation signal, the control unit 140 may be configured to at least one of open and close the internal switch 130. In this way, the control unit 140 may control the operation of the battery 100, at least relative to the load device. The control unit 140, through a connection 50 to a remote source, may at least receive a disconnect actuation signal to open the internal switch 130 causing the load device to lose power. In addition, the remote source through the connection 50 may provide a reconnect actuation signal to close the internal switch 130. In this way, one actuation signal may open the internal switch and the other actuation signal may close the internal switch. Alternatively, the control unit 140 may receive the actuation signal to close the internal switch 130 from an internal process, such as a timer or delay circuit for providing a predetermined delay period before automatically re-powering the load device. FIG. 1 illustrates the connection 50 as a dotted line in order to reflect that it may be a wired or wireless connection to the remote source. The control unit 140 may be implemented as a relatively simple electric circuit, a programmable computer controller using a non-transitory processor-readable storage medium or a combination thereof. The control unit 140 may be combined and integrated together with the internal switch 130 forming a single component.

The main energy storage element 110 may directly power the control unit 140. A first control unit lead 142 and a second control unit lead 144 may be directly connected to the main energy storage element 110 (e.g., electrodes 112 and 114, respectively). Thus, when the internal switch 130 is open, the control unit 140 may remain powered by the main energy storage element 110. FIG. 1 illustrates the connection between the control unit leads 142, 144 and the main energy storage element 110 as dotted lines to reflect that alternatively an auxiliary energy storage element may power the control unit 140 and/or internal switch 130. For example, an onboard backup energy cell (e.g., a button cell battery) may be included as an auxiliary energy storage element for powering the control unit 140 as described in more detail below. As a further example, the connection to a remote power source (e.g., connection 50), such as a micro-USB connection, may power the control unit 140. In this way, the control unit 140 need not lose power when the internal switch 130 is open (i.e., the battery 100 is not longer supplying power to the load device).

The housing 150 may be an enclosure for holding and at least partially containing the components of the battery 100, such as the main energy storage element 110, the internal switch 130, and the control unit 140. The two terminals 122, 124 extend outside of the housing for coupling to the load device. The housing 150 may be a rigid material intended to hold a shape and size or a more flexible material, such as a soft pouch, or some combination thereof. The housing 150 generally defines the outermost size and shape of the battery 100, which may vary to accommodate industry standards, a desirable form, or a particular load device. In addition, a non-conductive and/or conductive material may form the housing 150.

FIG. 2 illustrates a component block diagram of an exemplary load device 200, including the battery 100 with power disconnect according to various embodiments. The illustrated load device 200 is a mobile communication device, such as a cellular telephone, with a back cover removed to show some internal components, particularly the battery 100, within a load device casing 250. The load device in the various embodiments is not limited to mobile communication devices and may be any electrical device that includes and draws current from a battery. Thus, the load device may be any electrical device from a small consumer electronic device to a large-scale commercial machine

As illustrated in FIG. 2, a size and shape of the housing 150 of the battery 100 may be particularly suited to fit in a battery compartment 210 of the load device. The illustrated battery 100 may be similar to that described in the various embodiments. The compartment 210 also includes receiving terminals (not shown) for connecting to the two terminals of the battery 100 (e.g., the two terminals 122, 124 of FIG. 1). Regardless whether the battery 100 is easily accessible, such as through a removable back cover, getting at the battery 100 may generally be a difficult process and even sometimes require special tools. The various embodiments avoid the need to access and disconnect the battery, particular when the load device 200 becomes unresponsive.

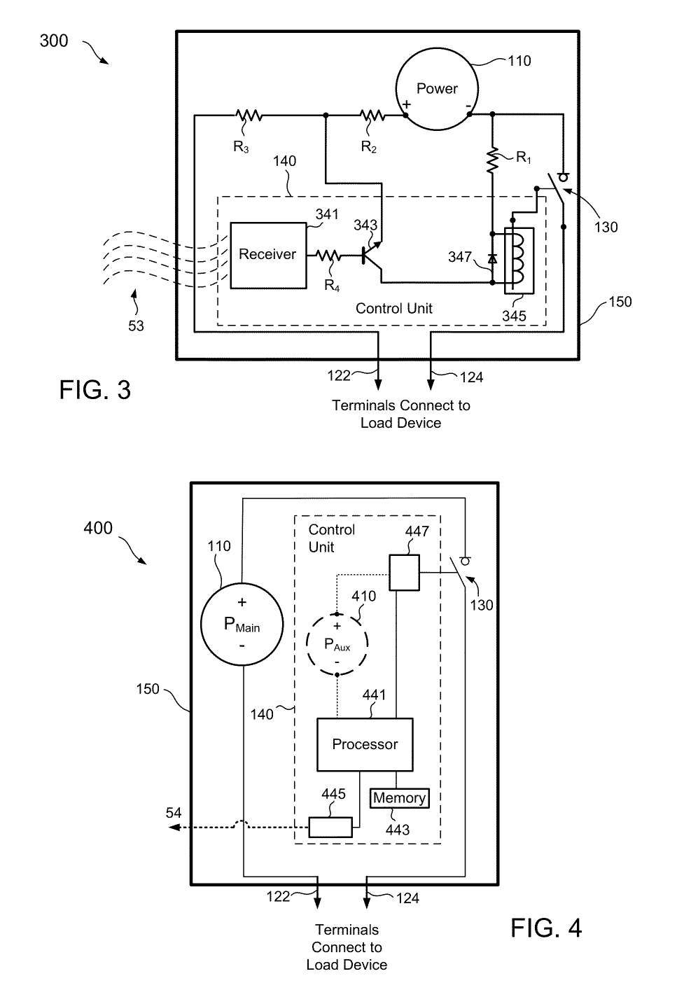

FIG. 3 illustrates an example embodiment circuit of a wirelessly controlled battery 300. As described above, the battery 300 may include the main energy storage element 110, two terminals 122, 124 for connecting to the load device, the internal switch 130, the control unit 140, and the housing 150. The control unit 140 of the battery 300 may include a receiver 341 for wirelessly receiving actuation signals 53 from a remote source. A transistor 343 connected to the receiver 341 may include a lead connected to a lead of the main energy storage element 110 and another lead connected to a lead of a solenoid 345 for actuating the internal switch 130. A lead of the main energy storage element 110 may connect to one of the battery terminals, such as terminal 122. The illustrated embodiment circuit shows an exemplary wired interconnection of those components, including various resistors R₁, R₂, R₃, R₄. Additional circuit components may be included and the location of particular components may be varied. Also, the resistance values of each resistor R₁, R₂, R₃, R₄ may be varied, and some components substituted or eliminated as needed.

The internal switch 130 may be one of various circuit interrupters that may be tripped by the solenoid 345. The solenoid 345 may be directly connected to a gate of the internal switch 130 for opening and closing thereof. A source and drain of the internal switch may connect to another one of the terminals, such as terminal 124, and a corresponding lead from the main energy storage element 110 of the corresponding polarity. Alternatively, a different type of actuation mechanism other than a solenoid may actuate the internal switch 130. Regardless, the internal switch 130 and its actuation mechanism should reliably open and/or close the internal circuit supplying power to the load device.

The control unit 140 may receive wireless remote actuation signals 53 through a wireless receiver 341. The wireless remote actuation signals 53 may be an electromagnetic field or radio frequency signals. Thus, the receiver 341 may be capable of converting information carried by the wireless remote actuation signals 53 to a usable form. The receiver 341 may include an antenna for intercepting the electromagnetic/radio waves and converting them to currents the receiver 341 may interpret. Upon receiving an appropriate set of currents corresponding to a predetermined actuation signal, the receiver 341 may allow a small electric current to reach the solenoid 345, which will in turn draw a larger electric current for actuating the internal switch 130. The control unit 140 may also include a bypass diode 347 for maintaining an isolated closed circuit between the control unit 140 and the main energy storage element 110 when the solenoid 345 operates to open the circuit.

In various embodiments, the receiver 341 may be designed and configured to detect the presence of a specific electromagnetic field signature or particular radio frequency signals forming the wireless remote actuation signals 53. Thus, the receiver 341 may include a magnetic sensor circuit configured to detect when a corresponding magnetic key, separate from both the battery 300 and the load device, may be in close proximity. Alternatively, the receiver 341 may include RFID technologies, such as an RFID reader for detecting the presence of and/or reading information contained in the wireless remote actuation signals 53. An RFID reader powered by the main energy storage element 110 may operate to detect remote actuation signals 53 many yards/meters away from the receiver 341 (as well as the load device in which it is loaded). Non-powered RFID readers may be more limited, detecting such wireless signals 53 at only a relatively short range (e.g., a few meters) of the receiver 341. An RFID transponder separate from the load device, which when brought in proximity and/or activated by a user may supply the wireless remote actuation signals 53. In this way, the user of the load device may be provided with a matching RFID transponder having a unique activation key for operating the control unit 140.

In various embodiments, the receiver 341 may communicate with a computing device that is not immediately adjacent to the battery 300 using long-range or mid-range wireless communications. For example, the receiver 341 may be equipped with a cellular transceiver, processor, and memory for handling cellular communications. Alternatively, the receiver 341 may communicate with a nearby computing device, such as the load device itself or a separate computing device, using mid-range wireless communications (e.g., Bluetooth®, ANT®, Zigbee®, etc.). Further, the receiver 341 may use communications to access and use long-range communications available through a separate device, such as the load device itself, which may be a mobile communication device, or a separate nearby device connected to a communication network. In addition, the receiver 341 may include a transmitter for two-way communication to and from the control unit 140. The transmission of outgoing communication from the receiver 341 may report a powered or unpowered state of the battery 300.

FIG. 4 illustrates another example embodiment of a battery 400 with power disconnect. The battery 400 may include the main energy storage element 110, two terminals 122, 124 for connecting to the load device, the internal switch 130, the control unit 140, and the housing 150. In contrast to battery 300 described above with reference to FIG. 3, the control unit 140 of the battery 400 is not powered by the main energy storage element 110. The control unit 140 of the battery 400 also may include a processor 441, internal memory 443, input bus 445, and actuation component 447. The actuation component 447 may be any electric component needed to trip the internal switch 130 (i.e., to open or close). Alternatively, the processor 441 may include internal circuitry capable of directly activating the internal switch 130, in which case the actuation component 447 may be redundant or unnecessary.

The processor 441 may be any programmable microprocessor, microcomputer or multiple processor chip or chips configured by software instructions (applications) to perform a variety of functions, including the functions of the various aspects described herein. The battery 400 may include multiple processors, such as one processor dedicated to wireless communication functions and one processor dedicated to controlling the circuit or running other applications. Typically, software applications may be stored in the internal memory 443 for access and loading into the processor 441. The internal memory 443 may be sufficient to store the application software instructions. In addition, the internal memory may be a volatile or nonvolatile memory, such as flash memory, or a mixture of both. For the purposes of this description, a general reference to memory refers to memory accessible by a processor including permanently fixed internal memory or removable memory plugged into the battery 400 and memory within the processor 441.

The input bus 445 may include receiver components for receiving actuation signals 54 wirelessly, similar to those described above with regard to the receiver 341 in FIG. 3. For example, the input bus 445 may include a Bluetooth module capable of receiving an actuation signal 53, which in turn triggers a kill switch using actuation components 447 to open the internal switch 130. In this way, the remote device (e.g., a computer, tablet, etc.) may wirelessly transmit a command using the Bluetooth connection to operate the kill switch. Security features may be included, requiring the remote device to use a passkey management application, in order to avoid an unauthorized third-party from activating or deactivating the kill switch. Options such as a changeable default password (e.g., “0000”) may enable a vendor or manufacturer to easily bypass the security feature initially, while providing security to an end-user who changes the password.

Alternatively, the input bus 445 may be a physical connection port for receiving a wired connection directly into the battery 400. Such a wired connection may extend outside the control unit 140 and the housing 150 for coupling to the remote source. By way of the input bus 445, the control unit 140 may receive, interpret and store actuation signals 54 configured to open or close the internal switch 130. In addition, the wired connection through input bus 445 may supply power from an external auxiliary energy storage element (not shown). For example, in embodiments in which the input bus 445 is a micro-USB connection, such a connection may be used to supply power to the control unit 140.

The battery 400 may further include an onboard auxiliary energy storage element 410 for powering the control unit 140 and/or actuating the internal switch 130. The onboard auxiliary energy storage element 410 may be a button or coin cell battery coupled to the control unit 140. With infrequent use, such coin cell batteries have a 1-10 year battery life. Onboard auxiliary energy storage element 410 may be a single-use energy cell or a rechargeable energy cell. As a rechargeable energy cell, the onboard auxiliary energy storage element 410 may be connected to the main energy storage element 110 or an external auxiliary energy storage element for recharging.

Although the onboard auxiliary energy storage element 410 is illustrated as being positioned in an interior space of the control unit 140, alternatively it may be coupled to the control unit 140 from outside the control unit 140 but still inside the battery housing 150 or completely outside the battery housing 150. In this way, the onboard auxiliary energy storage element 410 may supply power from a compartment within the housing 150 or through additional external terminals. The onboard auxiliary energy storage element 410 may connect between the processor 441 and the actuation component 447. In this way, the processor 441 and actuation component 447 may be powered for opening and/or closing the internal switch 130. While the onboard auxiliary energy storage element 410 may exclusively power the control unit 140, an external auxiliary energy storage element may alternatively do so or power the control unit 140 under limited circumstances. In this way, different auxiliary power supplies may power different functions of the battery 400. For example, the onboard auxiliary energy storage element 410 and the external auxiliary energy storage element may power the control unit 140 for opening and closing the internal switch, respectively, or vise-versa. Alternatively, the connection for the external auxiliary energy storage element may provide a backup fail-safe power connection.

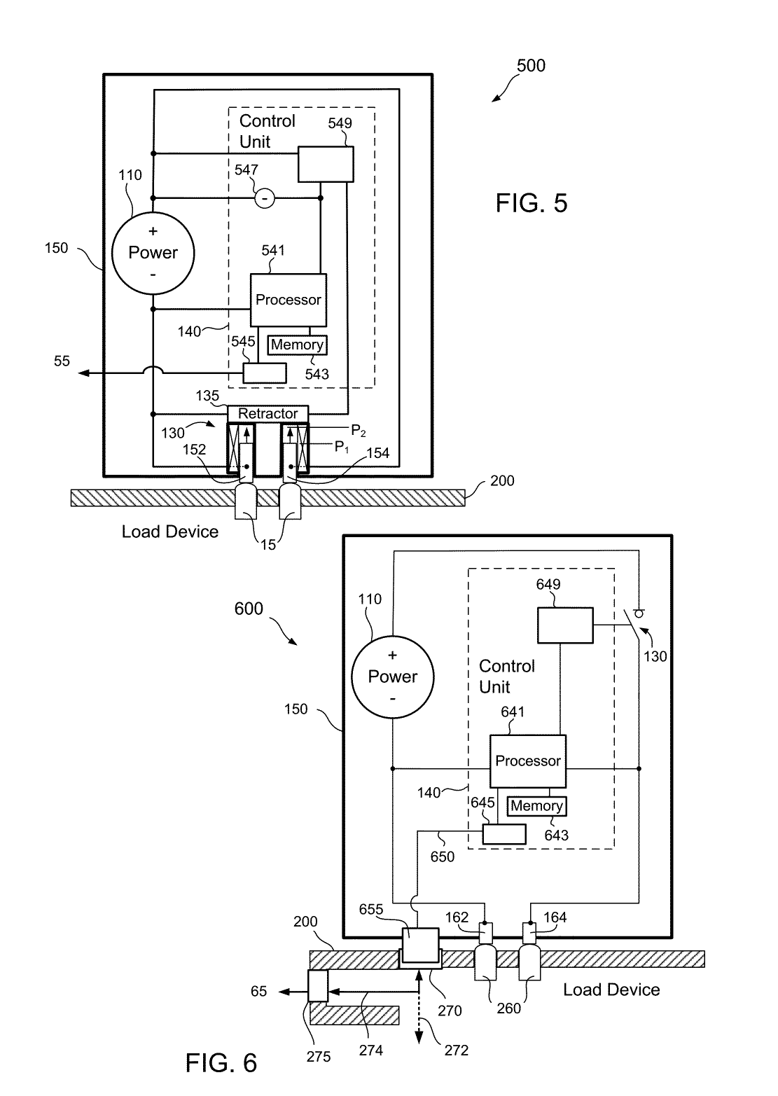

FIG. 5 illustrates another example embodiment of a battery 500 with power disconnect. The battery 500 may include the main energy storage element 110, two terminals 152, 154 for connecting to the load device 200, the internal switch 130, the control unit 140, and the housing 150. Similar to the battery 300 described above with reference to FIG. 3, the battery 500 may be powered by main energy storage element 110. Also, similar to the battery 400 described above with reference to FIG. 4, the battery 500 may include a processor 541, internal memory 543, input bus 545, and actuation component 549. The processor 541 also may include a bypass element 547 for powering the processor 541 independent of the actuation component 549. The input bus 545 may include a wired connection 55 extend outside the housing 150 of the battery 500 for receiving remote actuation signals. The wired connection 55 may couple to the load device 200 or be available for coupling to another remote device through an access panel of the load device. For example, as part of testing or service, a technician may remove an access panel of the load device to connect to the wired connection 55. Such the wired connection 55 may communicate with and even power the control unit 140.

In contrast to the batteries 300, 400 described above with reference to FIGS. 3 and 4, the internal switch 130 of the battery 500 may include a retractor mechanism 135 for physically separating at least one of the two terminals 152, 154 from engagement with at least one of the two load device contacts 15 (i.e., at least one connector lead). Although retractor mechanism 135 illustrates both terminals 152, 154 moving between a first position P₁ and a second position P₂, only one of the two terminals 152, 154 needs to be disengaged from the contacts 15 in order to open the circuit. In the first position P₁, an outermost portion of the terminals 152, 154 engages load device contacts 15 for supplying power to the load device 200. By sliding or pivoting at least one of the terminals 152, 154 to the second position P₂ a gap is formed between the terminals 152, 154 and the contacts 15, which opens the circuit. Reversing the retractor 135 to move the terminals 152, 154 to the first position P₁ once again closes the internal switch 130.

FIG. 6 illustrates another embodiment of a battery 600 with power disconnect. The battery 600 may include the main energy storage element 110, two terminals 162, 164 for connecting to the load device 200, the internal switch 130, the control unit 140, and the housing 150. The housing 150 fixedly holds the two terminals 162, 164 for coupling through engagement with contacts 260 of the load device 200. Similar to batteries 400, 500 described above with reference to FIGS. 4 and 5, the battery 600 may include a processor 641, an internal memory 643, an input bus 645, and an actuation component 649. Also, similar to the battery 300 described above with reference to FIG. 3, the main energy storage element 110 may power the control unit 140. However, unlike the battery 300 described above with reference to FIG. 3, the control unit 140 of the battery 600 is wired to disconnect from the main energy storage element 110 when the load device is disconnected. In particular, a first control unit lead may be connected to the main energy storage element 110, but a second control unit lead may be connected to an internal switch lead. In this way, the main energy storage element 100 may power the control unit 140 of the battery 600 to open the internal switch 130, but thereafter an auxiliary power source is needed to close the internal switch 130.

In this embodiment, the input bus 645 may include an internal wired connection 650 terminating in a wired connector 655 extend outside the housing 150 of the battery 600. The wired connector 655 may be sized and configured to mate with an internal load device connector 270 of the load device 200. The internal load device connector 270 may provide a fixed communication/power connection 272 to the load device 200. For example, the load device user may activate the power disconnect function of the battery 600 through a user interface or switch of the load device 200 via the connection 272. Alternatively, the internal load device connector 270 may provide a fixed communication/power connection 274 to an external load device connector 275. The external load device connector 275 may provide a wired coupling point for another external wired connection 65 beyond the load device 200. In this way, either the connection 272 to the load device 200 or the connection 65 to another device may supply power and/or an actuation signal to the control unit 140. For example, once the internal switch 130 of the battery 600 is open, an external auxiliary power source may be needed to close the internal switch 130. Thus, the external wired connection 65 may supply an auxiliary energy storage element. As a further alternative, the external load device connector 275 may be a sensor, such as an optical sensor, for receiving alternative wireless input signals for the control unit 140 of the battery 600.

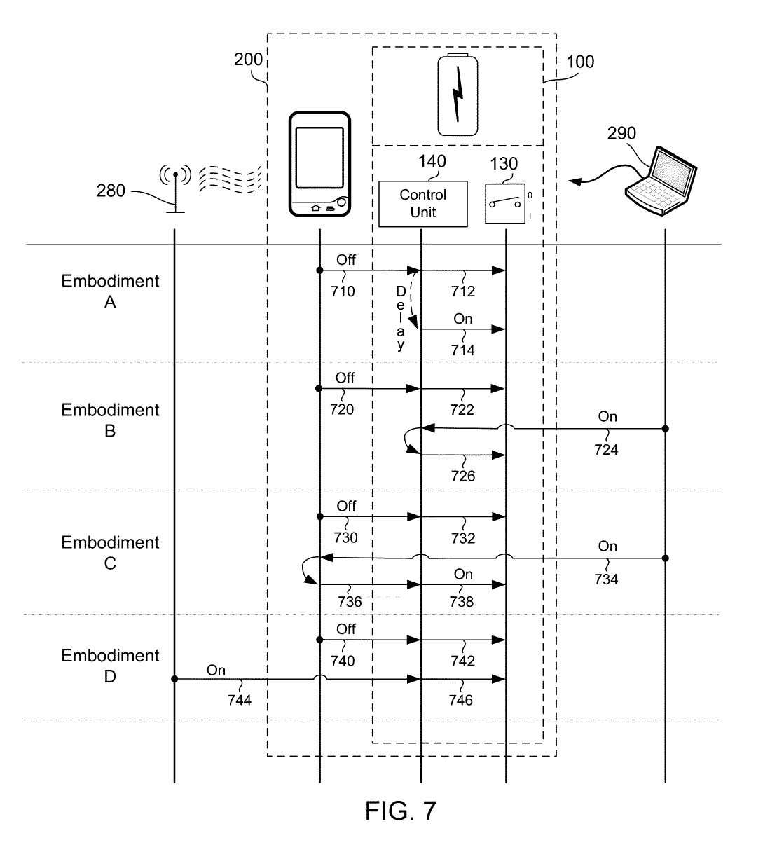

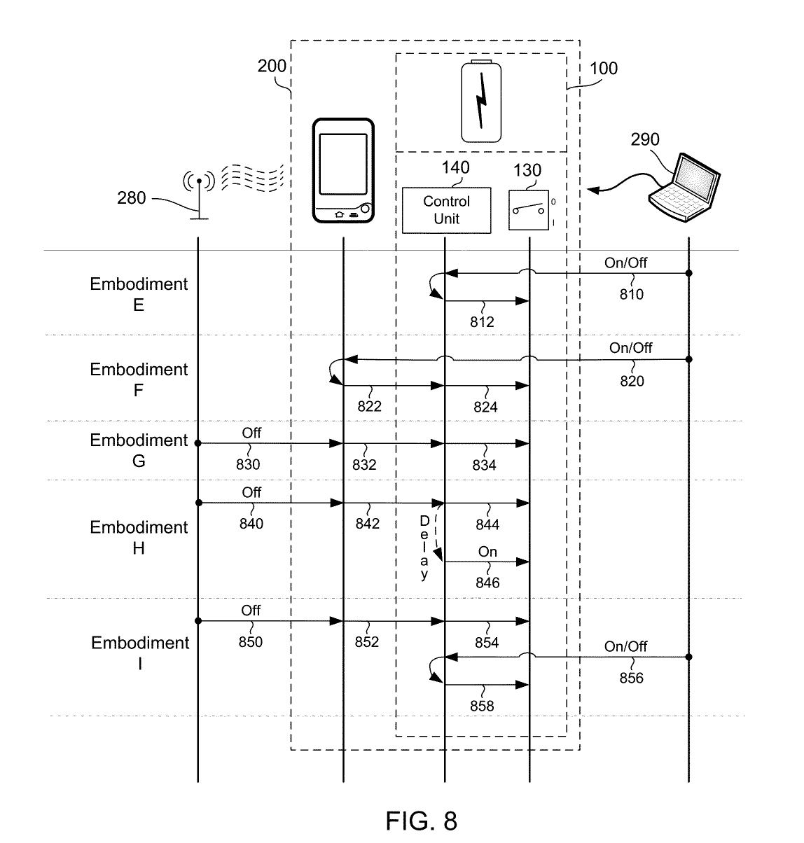

FIGS. 7 and 8 illustrate communication flows in various embodiments (i.e., embodiments A-I) showing how the battery 100 with power disconnect, may operate in various embodiments. The various embodiments (i.e., embodiments A-I) provide examples of different sources used to provide remote actuation signals and variations in the communication flow path to affect the disconnection and reconnection of power. The battery 100 may include elements of various embodiments described above with reference to FIGS. 3-6. In addition to an outer housing, the main energy storage element, and two terminals for coupling the battery to load device 200, the battery 100 may include the internal switch 130 and the control unit 140. In response to receiving an actuation signal, the control unit 140 may open and/or close the internal switch 130. The actuation signal may be received from the remote source, separate from the battery 100, such as at least one of the load device 200 or the remote actuation device 280, 290. The control unit 140 may receive the actuation signal either directly or via the load device acting as an intermediary. In addition, the control unit 140 may receive those actuation signals through a wired or a wireless connection. An embodiment wireless remote actuation device 280 may transmit the actuation signal using an electromagnetic field or radio frequency signals, which the control unit 140 may receive either directly or via the load device 200. Another embodiment remote actuation device 290 may use the wired connection to transmit an actuation signal and optionally power to the control unit 140. The signaling patterns of the various embodiment combinations of remote actuation devices and connections (i.e., direct/indirect or wired/wireless) are illustrated in the embodiments A-I in FIGS. 7 and 8.

The communication flows of the embodiments illustrated in FIG. 7 each start at a load device 200, which may include a user interface or a dedicated control for initiating the transmission of the actuation signals 710, 720, 730, 740 (i.e., “Off” signals) to the control unit 140 in battery 100. Considering that the load device 200 may be powered exclusively or primarily by the battery 100, once power is lost, the load device 200 may be incapable of transmitting or generating an “On” signal in order to regain power from the battery 100. However, if the load device 200 includes an alternative power source or has one made available, the load device 200 may be configured to also transmit an actuation signal corresponding to an On signal for reconnecting the battery 100 to the load device 200.

In embodiment A, the control unit 140 may include a timer or delay circuit for automatically reconnecting the main energy storage element of the battery 100 to the load device 200 after a predetermined interval. A processor of the control unit 140 with timer software or a time-delayed relay may provide a predetermined delay period. Designed to allow sufficient time for completely discharging powered circuits and providing a complete system reset of the load device, using the timer or delay circuit may eliminate the need to transmit the remote actuation signal to power back on the load device 200. In this embodiment, a user input or software control of the load device 200 may transmit the initial actuation signal 710 to the control unit 140 in the battery 100. In response to receiving the actuation signal 710, the control unit 140 may transmit an internal signal 712 to the internal switch 130, which in turn causes the load device 200 to lose power from the battery 100. The timer or delay mechanism may automatically start and signal the control unit 140 when the timer or delay expires. The timer or delay mechanism provides a means for determining when a predetermined period of time has transpired, as measured by the timer. In response to receiving a signal that timer or delay has expired, the control unit 140 may transmit an actuation signal 714 (i.e., an “On” signal) to the internal switch 130. The actuation signal 714 closes the control switch 130, reconnecting the battery 100 to the load device 200 after the delay period.

In embodiment B, the load device 200 initiates the power disconnect, but the remote actuation device 290, through its wired connection directly to the control unit 140, reconnects the main energy storage element of the battery 100 to the load device 200. In this embodiment, a user input or software control of the load device 200 may transmit the initial actuation signal 720 to the control unit 140. In response to receiving the actuation signal 720, the control unit 140 may transmit an internal signal 722 to the internal switch 130, which in turn causes the load device to lose power from the battery 100. The load device 200 may remain without power from the battery 100 for an indefinite period. A user or technician may need to open an access panel of the load device 200 in order to establish the wired connection from the remote actuation device 290 directly to the control unit 140. Alternatively, the load device 200 may include a dedicated port for coupling the remote actuation device 290 directly to the control unit 140. The remote actuation device 290 may transmit an actuation signal 724 (i.e., an “On” signal) to the control unit 140. This causes the control unit 140 to transmit a corresponding actuation signal 726, which closes the control switch 130. In this embodiment, the load device 200 regains power from the battery 100 after losing power without physically removing the battery 100 from the load device 200.

Embodiment C may be similar to embodiment B, except that the remote actuation device 290 has the wired connection generally to the load device 200, rather than a direct connection to the control unit 140. Once again, the load device 200 initiates the power disconnect (e.g., responding to user input or software control) and the remote actuation device 290 reconnects the main energy storage element of the battery 100 to the load device 200. In response to receiving an initial actuation signal 730, the control unit 140 may transmit an internal signal 732 to the internal switch 130, which in turn causes the load device to lose power from the battery 100. Subsequently, the remote actuation device 290 transmits an actuation signal 734 (i.e., an “On” signal) to the load device 200. As with embodiment B, a user or technician may need to plug-in the wired connection between the remote actuation device 290 and the load device 200. For example, a micro-USB connection may supply temporary power and enable the processor of the load device 200 to receive signals from the remote actuation device 290. The subsequent actuation signal 734 from the remote actuation device 290 causes the load device 200 to convey an intermediate actuation signal 736 to the control unit 140. This may cause the control unit 140 to transmit a corresponding actuation signal 738, which closes the control switch 130 and reestablishes power from the main energy storage element of the battery 100 to the load device 200.

Embodiment D may be similar to embodiment B, except that a wireless connection to the remote actuation device 280 supplies an actuation signal for turning the load device 200 back on. The load device 200 may initiate the power disconnect (e.g., responding to user input or software control) and the remote actuation device 280 reconnects the main energy storage element of the battery 100 to the load device 200. In response to receiving an initial actuation signal 740, the control unit 140 may transmit an internal signal 742 to the internal switch 130, which in turn causes the load device to lose power from the battery 100. Subsequently, the wireless remote actuation device 280 transmits an actuation signal 744 (i.e., an “On” signal) to the control unit 140. Although the remote actuation device 280 does not require a wired connection, the control unit 140 may need to remain powered when the load device 200 loses power in order to be able to receive the subsequent actuation signal 744. For example, the remote actuation device 280 may be an RFID tag recognized by the control unit 140. The subsequent actuation signal 744 from the remote actuation device 280 may cause the control unit 140 to transmit a corresponding actuation signal 746, which closes the control switch 130 and reestablishes power from the main energy storage element of the battery 100 to the load device 200.

The communication flows in FIG. 8 illustrate signaling in embodiments in which the remote actuation devices 280, 290 initiate the actuation signals, rather than the load device 200. Being able to activate the power disconnect function from a remote source other than the load device 200 may be useful in various situations. For example, when a valuable load device 200 has been lost or stolen, the owner may remotely communicate a disabling actuation signal preventing unauthorized access to it. As another example, a test engineer may signal the power disconnect from an external device to force a hard boot of a load device during testing, such as when a test has placed the load device in a non-responsive state. As a further example, an authorized service technician may access the power disconnect function to assist a user whose device has become unresponsive or warrants a power disconnect for any reason. Considering that remote actuation of the power disconnect function from a device other than the load device may raise security issues, additional security precautions may be implemented before such remote access is granted.

In embodiment E, the remote actuation device 290, through its wired connection directly to the control unit 140, may either open or close the internal switch 130 in the battery 100. For example, the remote actuation device 290 may be a tool used by a technician or test engineer for diagnostic testing and/or repair of the load device 200. This embodiment E includes situations in which the battery 100 may be tested or serviced separately and not actually installed in or connected to the load device 200. The remote actuation device 290 may transmit the initial actuation signal 810 to the control unit 140. In response to receiving the actuation signal 810, the control unit 140 may transmit an internal signal 812 to the internal switch 130, which in turn causes the load device to either lose or regain power from the battery 100. In embodiment E, the actuation signal 810 may correspond to either an Off signal or an On signal, since in accordance with various embodiments the control unit 140 may draw power from the main battery main energy storage element, an alternative source of electrical power, or the remote actuation device 290 through its wired connection.

An alternative embodiment, not shown, may employ the wireless remote actuation device 280 communicating directly to the control unit 140. However, since such a remote actuation device 280 uses the wireless connection, the control unit 140 may need to still have access to power from the main energy storage element or an alternative source of electric power in order to receive actuation signals corresponding to an On signal. Otherwise, the wireless remote actuation device 280 may be limited to transmitting actuation signals corresponding to an Off signal to the control unit 140.

In embodiment F, the remote actuation device 290, through its wired connection to the control unit 140 via the load device 200, may either open or close the internal switch 130 in the battery 100. The remote actuation device 290 may transmit the initial actuation signal 820 to the control unit 140. In response to receiving the actuation signal 820, the load device 200 may transmit an intermediate activation signal 822 to the control unit 140. The control unit 140 may in turn transmit an internal signal 824 to the internal switch 130, which causes the load device to either lose or regain power from the battery 100. In embodiment F, the actuation signal 820 may correspond to either an Off signal or an On signal since in accordance with various embodiments the control unit 140 may draw power from the main energy storage element, an alternative source of electric power, or the remote actuation device 290 through its wired connection to the load device 200.

In embodiment G, the wireless remote actuation device 280 may emit a remote actuation signal 830 (i.e., an “Off” signal) received by the load device 200, which may be then communicated to the control unit 140. For example, the load device 200, such as a cell phone, may receive short-range communications (e.g., Bluetooth® or Wi-Fi) or long-range communications (e.g., cellular technologies) including the remote actuation signal 830. A processor of the load device 200 may convey an intermediate actuation signal 832 to the control unit 140 through available wired or wireless connections. In response to receiving the intermediate actuation signal 832, the control unit 140 may transmit an internal actuation signal 834 to the internal switch 134 disconnecting power from the load device 200. As noted above, once the load device 200 is no longer receiving power from the battery 100 it may no longer be able to receive and convey signals. However, if the load device 200 includes an auxiliary energy storage element (e.g., a backup battery) or has an alternative source of electric power made available, the wireless remote actuation device 280 may transmit an actuation signal corresponding to an On signal to the load device 200 to reconnect power from the battery 100.

Embodiment H combines aspects of embodiment A with embodiment G. In particular, a remote actuation signal 840 (i.e., an “Off” signal) may be received by the load device 200 from the wireless remote actuation device 280, with an intermediate actuation signal 842 conveyed to the control unit 140, and an internal actuation signal 844 sent to the internal switch 130. In response to receiving the intermediate actuation signal 842, the control unit 140 may use a timer or delay circuit for automatically reconnecting the main energy storage element of the battery to the load device after a predetermined interval. The timer or delay mechanism may automatically start and signal the control unit 140 when the timer or delay expires. In response to receiving a signal that timer or delay has expired, the control unit 140 may transmit an actuation signal 746 (i.e., an “On” signal) to the internal switch 130. after the delay period. The actuation signal 746 closes the control switch 130, reconnecting the battery 100 to the load device 200 after the delay period. A related embodiment, not shown, may employ the wireless remote actuation device 280 communicating directly to the control unit 140. For example, the remote actuation device 280 may be a short-range device using an RFID tag or magnetic signals.

Embodiment I may include aspects of both embodiment G and embodiment E. In this embodiment, the wireless remote actuation device 280 may emit a remote actuation signal 850 (i.e., an “Off” signal) received by the load device 200, which may be then communicated to the control unit 140. A processor of the load device 200 may convey an intermediate actuation signal 852 to the control unit 140, through available wired or wireless connections. In response to receiving the intermediate actuation signal 852, the control unit 140 may transmit an internal actuation signal 854 to the internal switch 134 disconnecting power from the load device 200. Once powered-off, a wired connection may be needed to reset the internal switch 130. The wire-connected remote actuation device 290 may transmit an actuation signal 856 to the control unit 140. In response to receiving the actuation signal 856, the control unit 140 may transmit an internal signal 858 to the internal switch 130 to reconnect power. In addition, once the wired connection is established between control unit 140 and remote actuation device 290, either an Off signal or an On signal may be transmitted by the control unit 140 as described above.

The battery disconnect function of various embodiments (which may include the reconnection option) may create security issues for the load device without providing security protections. For example, a simple magnetically activated internal switch 130 or control unit 140 may provide a low level of security. A unique RFID tag or other key device may also prevent unauthorized third-party kills or inadvertent power disconnection/reconnection with a higher level of security. Similarly, a software-based application executed by a processor, in either control unit 140 or elsewhere (e.g., the load device 200 or remote actuation devices 280, 290), may provide a high degrees of security.

Using a passkey management application may ensure only authorized users or service personnel use the disconnect function. For example, a user may enter a secure disconnect code using security software either directly in a user interface of the load device to ensure no one else uses the load device. Similarly, a user who has lost a rather valuable load device with wireless communication capabilities (e.g., a mobile phone) may remotely access the load device discretely through the security software to disconnect power.

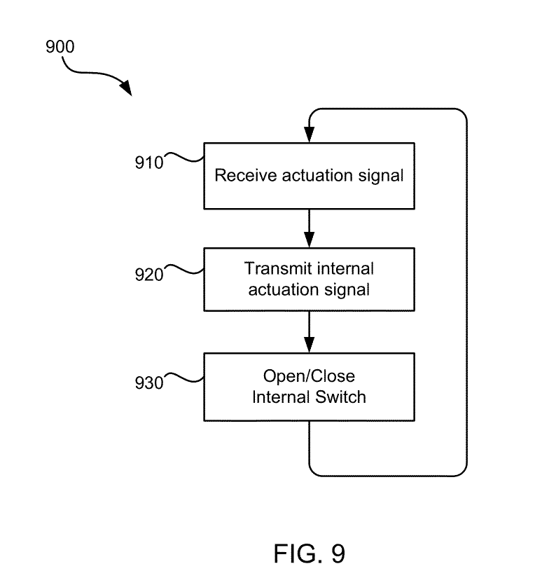

FIG. 9 illustrates an embodiment method 900 of controlling a disconnect feature of an embodiment battery with power disconnect. In block 910, the control unit may receive an actuation signal. The actuation signal may be received from a remote source, such as the load device or another remote device. For example, a processor in a control unit may receive a first switch signal via an input bus. In response to receiving the actuation signal, the control unit may transmit an internal actuation signal configured to open and/or close the internal switch in block 920. In embodiments in which the control unit includes a processor coupled to memory, the processor may also store the first switch signal in the memory.

In block 930, the internal switch may open or close the internal switch in accordance with the actuation signal. Although the load device powered by the battery may lose power when the internal switch is open, the control unit need not lose power. For example, the control unit may remain powered by an auxiliary energy storage element/battery when the internal switch is open. Such an auxiliary energy storage element may be included in the battery housing or as part of the remote device. The control unit may include a receiver module for receiving the actuation signal from the remote source. The process may receive further actuation signals in block 910, such as a subsequent actuation signal to reverse the opening or closing of the internal switch.

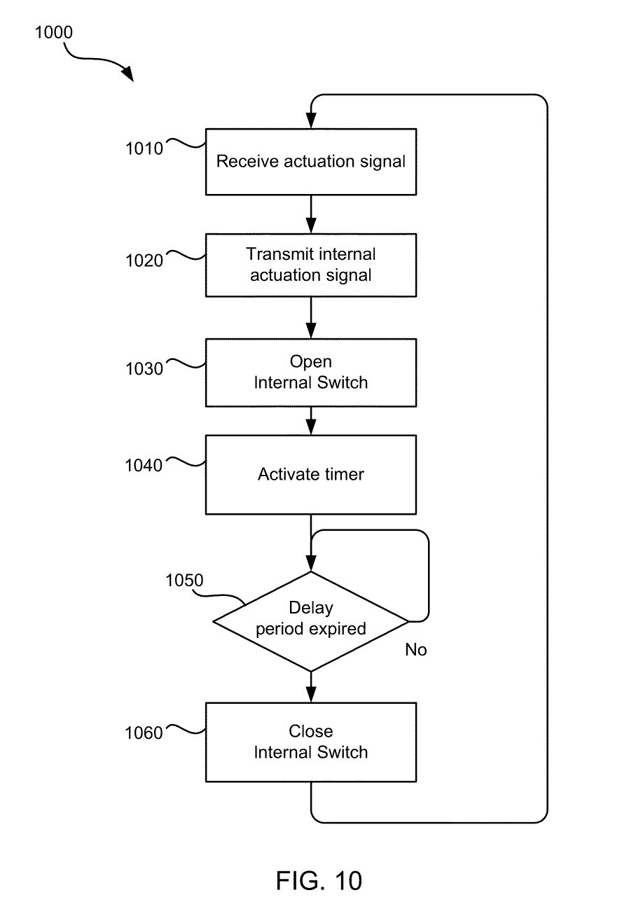

FIG. 10 illustrates a further embodiment method 1000 of controlling the disconnect feature of an embodiment battery with power disconnect. In addition to those elements included in the battery utilized in the method 900 described above with reference to FIG. 9, this embodiment method may be implemented with an embodiment battery that includes a timer or delay circuit. In block 1010, the control unit may receive an actuation signal. The actuation signal may be received from a remote source, such as the load device or another remote device. For example, a processor in the control unit may receive a first switch signal via an input bus. In response to receiving the actuation signal, the control unit may transmit an internal actuation signal configured to open and/or close the internal switch in block 1020. In embodiments in which the control unit includes the processor coupled to memory, the processor may also store the first switch signal in the memory.

In block 1030, the control unit may open the internal switch. In block 1040, a delay circuit or timer may actuate. In embodiments in which the control unit includes a processor, the processor may activate a timer function in block 1040. In determination block 1050, the delay circuit may wait for expiration of its predetermined period before closing the internal switch in block 1060. In embodiments in which the control unit includes a processor, the processor may determine whether the delay period expired in determination block 1050, repeating the determination periodically so long as the delay period has not expired (i.e., determination block 1050=“No”). In response to determining that the delay period has expired (i.e., determination block 1050=“Yes”), the control unit may close the internal switch in block 1060. The method may be repeated as the control unit may receive an actuation signal process may receive further actuation signals in block 1010, such as a subsequent actuation signal to open the internal switch.

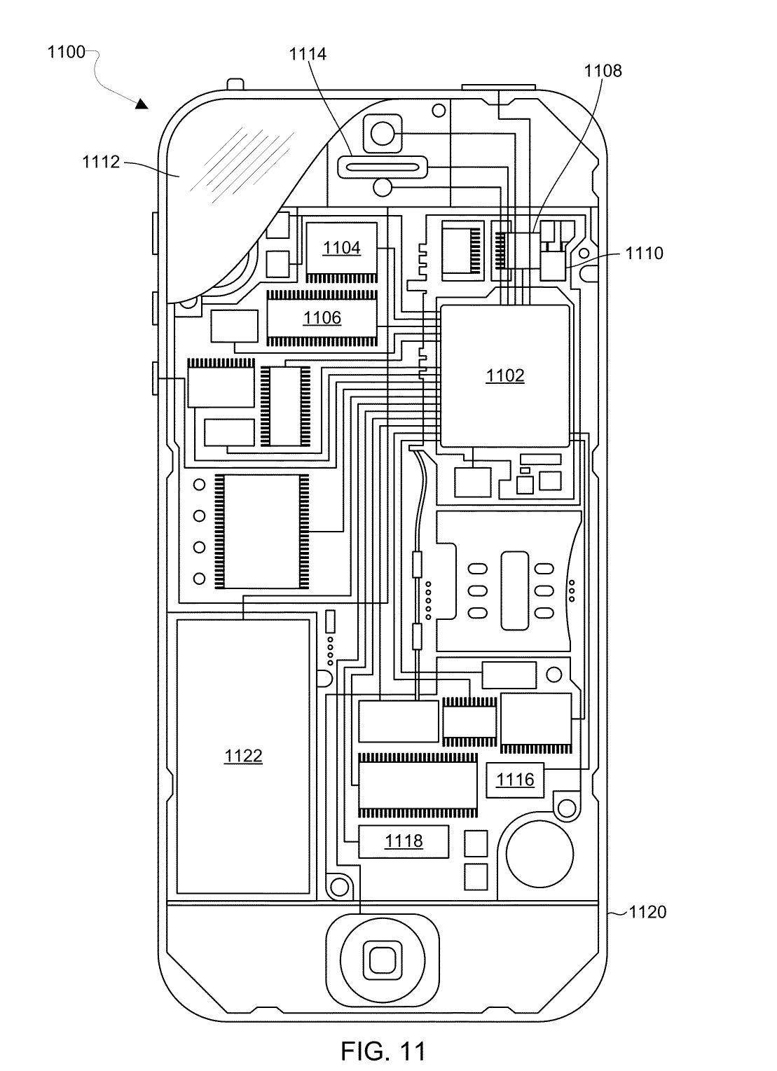

The various aspects may be implemented in and/or with any of a variety of computing devices, an example of which is illustrated in FIG. 11 in the form of a cellular telephone. In this way, the load device and/or remote actuation devices in various embodiments may be a computing device as illustrated in FIG. 11 and as described below. The various aspects may be implemented in and/or with any of a variety of other computing devices, such as a tablet computer, laptop computer, desktop computer or other computing device. In various aspects, the computing device 1100 may include a processor 1102 coupled to a touchscreen controller 1104 and an internal memory 1106. The processor 1102 may be one or more multicore ICs designated for general or specific processing tasks. The internal memory 1106 may be volatile or non-volatile memory such as NAND, and may be secure and/or encrypted memory, or unsecure and/or unencrypted memory, or any combination thereof The processor 1102 may be coupled to a touchscreen controller 1104. The touchscreen controller 1104 and the processor 1102 may also be coupled to a touchscreen panel 1112, such as a resistive-sensing touchscreen, capacitive-sensing touchscreen, infrared sensing touchscreen, etc. Alternatively, the various aspects may be implemented in and/or with any of a variety of devices that do not include a touchscreen controller, touchscreen or any form of screen or direct data interface, such as a data card, wireless hotspot device, network component, peripheral memory device or similar “headless” devices. The computing device 1100 may have one or more radio signal transceivers 1108 (e.g., Peanut®, Bluetooth®, Zigbee®, Wi-Fi, RF radio) and antennae 1110, for sending and receiving, coupled to each other and/or to the processor 1102. The transceivers 1108 and antennae 1110 may be used with the above-mentioned circuitry to implement the various wireless transmission protocol stacks and interfaces. The computing device 1100 may include a cellular network wireless modem chip 1116 coupled to the processor that enables communication via a cellular network. The computing device 1100 may include a peripheral device connection interface 1118 coupled to the processor 1102. The peripheral device connection interface 1118 may be singularly configured to accept one type of connection, or multiply configured to accept various types of physical and communication connections, common or proprietary, such as USB, FireWire, Thunderbolt, or PCIe. The peripheral device connection interface 1118 may also be coupled to a similarly configured peripheral device connection port (not shown). The computing device 1100 may also include speakers 1114 for providing audio outputs. The computing device 1100 may also include a casing 1120, constructed of a plastic, metal, or a combination of materials, for containing all or some of the components discussed herein. The computing device 1100 may include a battery 1122 coupled to the processor 1102, such as a battery with power disconnect in accordance with various embodiments herein. The battery 1122 may also be coupled to the peripheral device connection port to receive a charging current from a source external to the computing device 1100.

The processors in the various aspects described herein may be any programmable microprocessor, microcomputer or multiple processor chip or chips that can be configured by instructions (i.e., software instructions, such as applications) to perform a variety of functions, including the functions of the various aspects described above. In some devices, multiple processors may be provided, such as one processor dedicated to wireless communication functions and one processor dedicated to running other applications. Typically, before being accessed and loaded into the processors, software applications may be stored in the internal memory. The processors may include internal memory sufficient to store the application instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processor themselves.

The foregoing method descriptions and the process and communication flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the,” is not to be construed as limiting the element to the singular.

The various illustrative logical blocks, modules, circuits, and algorithm steps described in connection with the aspects disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, processor, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a non-transitory processor medium. The operations of a method or algorithm disclosed herein may be embodied in a processor-executable software module that may be stored on a non-transitory processor storage medium. Non-transitory processor storage media may be any available media that may be accessed by a processor. By way of example, and not limitation, such non-transitory processor media may comprise RAM, ROM, EEPROM, CD-ROM or other optical disk storage, magnetic disk storage or other magnetic storage devices, or any other medium that may be used to store desired processor executable code in the form of instructions or data structures and that may be accessed by a processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory processor media. Additionally, the operations of a method or algorithm may reside as one or any combination or set of codes and/or instructions on a non-transitory machine-readable medium and/or processor medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A battery for supplying electrical energy to a load device, the battery comprising:
a main energy storage element configured to supply power to the load device;
terminals for coupling the main energy storage element to the load device;
an internal switch including a first switch lead connected to the main energy storage element and a second switch lead connected to at least one of the terminals, wherein the internal switch is configured so that power from the main energy storage element is supplied to the load device when the internal switch is closed and the load device is disconnected from the main energy storage element when the internal switch is open;
a control unit coupled to the internal switch and configured to open or close the internal switch in response to receiving an actuation signal; and
a housing at least partially containing the main energy storage element, the internal switch and the control unit, wherein the terminals extend outside of the housing for electrically coupling to the load device.

2. The battery of claim 1, wherein the control unit is powered by an auxiliary energy storage element and remains powered when the internal switch is open.

3. The battery of claim 1, wherein the control unit is powered by the main energy storage element and remains powered by the main energy storage element when the internal switch is open.

4. The battery of claim 1, wherein the control unit comprises a receiver module configured to receive the actuation signal from a remote source.

5. The battery of claim 4, wherein the receiver module comprises at least one of an antenna, a radio frequency identification (RFID) reader, a bus connection extending outside of the housing, and a magnetic sensor circuit.

6. The battery of claim 1, wherein the control unit comprises:
an input bus; and
a processor coupled to the input bus and the internal switch, wherein the processor is configured with processor-executable instructions to perform operations comprising:
receiving a first switch signal via the input bus; and
opening the internal switch in response to receiving the first switch signal.

7. The battery of claim 6, wherein the processor is configured with processor-executable instructions to perform operations further comprising:
receiving a second switch signal via the input bus; and
closing the internal switch in response to receiving the second switch signal.

8. The battery of claim 1, wherein:
the internal switch is a retractor;
the terminals are moveable by the retractor between a first position in which at least one of the terminals engages a connector lead of the load device and a second position in which the at least one of the terminals is spaced apart from the connector lead of the load device; and
the at least one of the terminals is in the first position when the internal switch is closed and the at least one of the terminals is in the second position when the internal switch is open.

9. The battery of claim 1, further comprising a timer coupled to the control unit and configured to start when the internal switch is opened, wherein the control unit is configured to close the internal switch upon expiration of a predetermined period of time measured by the timer.

10. A battery for supplying electrical energy to a load device, the battery comprising:
a housing;
a main energy storage element within the housing configured to supply power to the load device;
means for receiving a disconnect actuation signal; and
means for disconnecting the main energy storage element from the load device in response to the disconnect actuation signal, wherein the means for disconnecting is within the housing.

11. The battery of claim 10, further comprising:
means for receiving a reconnect actuation signal; and
means for reconnecting the main energy storage element to the load device in response to the reconnect actuation signal, wherein the means for reconnecting is within the housing.

12. The battery of claim 11, further comprising:
means for powering from an auxiliary energy storage element the means for reconnecting the main energy storage element to the load device, wherein means for reconnecting the main energy storage element to the load device remains powered by the auxiliary energy storage element when the main energy storage element is disconnected from the load device.

13. The batter of claim 12, wherein the auxiliary energy storage element is disposed within the housing.

14. The battery of claim 10, wherein means for receiving the disconnect actuation signal comprises at least one of an antenna, a radio frequency identification (RFID) reader, a bus connection extending outside of the housing, and a magnetic sensor circuit.

15. The battery of claim 10, wherein the means for disconnecting the main energy storage element from the load device in response to the disconnect actuation signal comprises means for retracting a terminal of the battery so that it no longer contacts a connector lead of the load device in response to the disconnect actuation signal.

16. The battery of claim 10, further comprising:
means for determining when a predetermined period of time has transpired since the main energy storage element was disconnected from the load device; and means for reconnecting the main energy storage element to the load device in response to determining that the predetermined period of time has transpired, wherein the means for reconnecting is within the housing.

17. A method of disconnecting power from an electrical device powered by a battery having within a housing of the battery a main energy storage element, an internal switch configured to connect and disconnect the main energy storage element from the electrical device, and a control unit coupled to the internal switch and configured to cause the internal switch to open or close in response to receiving an actuation signal, the method comprising:
sending the actuation signal to the control unit.

18. The method of claim 17, further comprising:
sending another actuation signal to the control unit, wherein one actuation signal opens the internal switch and the other actuation signal closes the internal switch.

19. The method of claim 17, wherein sending the actuation signal to the control unit includes using at least one of a radio frequency identification (RFID) transponder, a bus connection extending outside of the housing, and a magnetic sensor circuit.

20. The method of claim 17, further comprising:
powering the control unit from an auxiliary energy storage element, wherein the control unit remains powered by the auxiliary energy storage element when the main energy storage element is disconnected from the electrical device.
